(19) United States
(12) Patent Application Publication
(10) Pub. No.: US 2019/0031864 A1
(43) Pub. Date: Jan. 31, 2019

(54) TIRE

(71) Applicant: SUMITOMO RUBBER INDUSTRIES, LTD., Hyogo (JP)

(72) Inventor: Fumiya KATO, Kobe-shi (JP)

(73) Assignee: SUMITOMO RUBBER INDUSTRIES, LTD., Hyogo (JP)

(21) Appl. No.: 16/027,169

(22) Filed: Jul. 3, 2018

(30) Foreign Application Priority Data
Jul. 26, 2017 (JP) 2017-144388

(51) Int. Cl. C08L 9/06; C08K 3/04; C08K 3/06; B60C 1/00

(52) U.S. Cl. CPC C08L 9/06; B60C 1/0016; C08K 3/06; C08K 3/04

(57) ABSTRACT

There is provided a tire having good initial grip performance. The tire comprises a tread composed of a rubber composition for the tread, and the rubber composition comprises a styrene-butadiene rubber having a weight-average molecular weight of 700,000 or more, a high content of styrene monomer and a vinyl content of 30 to 55%, a styrene-butadiene polymer having a weight-average molecular weight of 30,000 or less, carbon black and sulfur.

### TECHNICAL FIELD

The present invention relates to a tire comprising a tread composed of a specified rubber composition for a tread.

### BACKGROUND OF THE INVENTION

A tread of a tire is desired to keep an excellent grip performance from an initial stage up to an end of running. During the running, since a tire is warm, a grip force is easily exhibited, while at an initial stage of the running, there is a problem such that a grip force is hardly exhibited since a tire is not warm.

In a rubber composition for a tread, a method of improving grip performance by blending a resin having a specific softening point has been studied (e.g. see JP 2004-137463 A). For the purpose of improving an initial grip performance, a method of increasing a compounding amount of a low softening point resin, a liquid polymer or the like and a method of compounding a low-temperature softening agent have been studied. However, there is still a room for improvement.

### SUMMARY OF THE INVENTION

An object of the present invention is to provide a tire having good initial grip performance.

The present invention relates to a tire comprising a tread composed of a rubber composition for a tread, the rubber composition comprises a styrene-butadiene rubber having a weight-average molecular weight of 700,000 or more, a high content of styrene monomer and a vinyl content of 30 to 55%, a styrene-butadiene polymer having a weight-average molecular weight of 30,000 or less, carbon black and sulfur.

It is preferable that in the styrene-butadiene rubber, a content of dimers and trimers of styrene is 5 to 20% and a content of tetramers and higher multimers of styrene is 10% or less.

It is preferable that a styrene content of the styrene-butadiene rubber is 30 to 55% by mass.

### DETAILED DESCRIPTION

A tire comprising a tread composed of a specified rubber composition for a tread has good initial grip performance.

A tire according to one embodiment of the present disclosure is featured by comprising a tread composed of a rubber composition for a tread comprising a styrene-butadiene rubber (SBR) having a weight-average molecular weight of 700,000 or more, a high content of styrene monomer and a vinyl content of 30 to 55%, a styrene-butadiene polymer having a weight-average molecular weight of 30,000 or less, carbon black and sulfur.

The inventor of the present invention have found that in order to improve grip performance immediately after start of running from standstill, it is important to reduce a complex elastic modulus at around 70° C. and use a rubber composition for a tread having less temperature dependency. In the rubber composition for a tread according to the present disclosure, it is considered that by combination use of SBR having a weight-average molecular weight Mw of 700,000 or more and a high content of styrene monomer with a styrene-butadiene polymer having a weight-average molecular weight Mw of 30,000 or less, the SBR having a high content of styrene monomer is mixed sufficiently with the low molecular weight styrene-butadiene polymer having a small crystallinity, and as a result, a complex elastic modulus at around 70° C. can be made smaller and temperature dependency can be decreased.

In the rubber composition for a tread according to one embodiment of the present disclosure, the complex elastic modulus E*₇₀ under conditions of 70° C., an initial strain of 10%, a dynamic strain of 2% and a frequency of 10 Hz is preferably 110 MPa or less, more preferably 100 MPa or less, further preferably 90 MPa or less from the viewpoint of initial grip performance and grip performance during running. It is noted that the complex elastic modulus is preferably 30 MPa or more, more preferably 40 MPa or more, further preferably 50 MPa or more from the viewpoint of steering stability and fuel efficiency.

In the rubber composition for a tread according to this embodiment of the present disclosure, temperature dependency of a complex elastic modulus can be evaluated, for example, by the following equation (1). It is noted that in the equation (1), E*n represents a complex elastic modulus at n° C. As the value of the equation (1) gets closer to 1, temperature dependency is reduced.

(E*₅₀+E*₁₀₀)/(2×E*₇₀) (1)

The value of the equation (1) being as close to 1 as possible is preferable, and the value is preferably one or more and 10 or less, more preferably one or more and 7 or less, further preferably one or more and 5 or less, most preferably one or more and 3 or less.

### <Styrene-Butadiene Rubber>

The SBR is a styrene-butadiene rubber having a weight-average molecular weight of 700,000 or more and a high content of styrene monomer. Here, the weight-average molecular weight of the SBR as used herein is a weight-average molecular weight calibrated with standard polystyrene based on measurement values determined with a gel permeation chromatography (GPC).

In this embodiment of the present disclosure, “a styrene-butadiene rubber having a high content of styrene monomer” means a styrene-butadiene rubber, in which the content of continuous bonds of styrene monomers constituting the styrene-butadiene rubber, namely the content of component units comprising styrene dimers and higher multimers is small, and the content of component units comprising styrene monomers is large. More specifically, the styrene-butadiene rubber having a high content of styrene monomer is a styrene-butadiene rubber, in which the content of dimers and trimers of styrene constituting the styrene-butadiene rubber is small and/or the content of tetramers and higher multimers of styrene is small. Example of “a high content of styrene monomer” includes a case where the content of dimers and trimers of styrene constituting the styrene-butadiene rubber is 5 to 20/a % and/or the content of tetramers and higher multimers of styrene is 10% or less.

The weight-average molecular weight of the SBR is 700,000 or more, preferably 900,000 or more, more preferably 1,100,000 or more. When the weight-average molecular weight is less than 700,000, abrasion resistance tends to deteriorate. The upper limit of the weight-average molecular weight is not limited particularly, and is preferably 1,500,000 or more from the viewpoint of initial grip performance and abrasion resistance.

Since the SBR is a styrene butadiene rubber having a high content of styrene monomer, it is mixed sufficiently with the styrene butadiene polymer described later, and therefore, it is considered that E*₇₀ can be made small and temperature dependency can be reduced. The content of dimers and trimers of styrene constituting the styrene-butadiene rubber is preferably 5 to 20%, more preferably 10 to 20%, more preferably 13 to 17% from the viewpoint of initial grip performance. Further, the content of tetramers and higher multimers of styrene is preferably 10% or less, more preferably 70% or less from the viewpoint of initial grip performance. A lower limit of the content of tetramers and higher multimers of styrene is not limited particularly, and a smaller lower limit is preferable. It is noted that herein the content of dimers and trimers of styrene constituting the styrene-butadiene rubber is determined by gas chromatography analysis.

The styrene content of the SBR is preferably 30% by mass or more, more preferably 35% by mass or more, further preferably 40% by mass or more from the viewpoint of grip performance during running. Further, the styrene content is preferably 55% by mass or less, more preferably 50% by mass or less, further preferably 45% by mass or less from the viewpoint of initial grip performance. It is noted that herein, the styrene content of the SBR indicates a content of styrene portions in the SBR, and is calculated by H¹-NMR measurement.

The vinyl content of the SBR is preferably 30% or more, more preferably 35% or more, further preferably 40% or more from the viewpoint of grip performance during running. Further, the vinyl content is preferably 55% or less, more preferably 50% or less, further preferably 45%6 or less from the viewpoint of initial grip performance. It is noted that herein, the vinyl content of the SBR indicates a unit quantity of 1,2-bonds in butadiene portions of the SBR, and is measured by an infrared absorption spectrum analysis method.

A glass transition temperature (Tg) of the SBR is preferably −35° C. or higher, more preferably −20° C. or higher from the viewpoint of grip performance during running. The Tg of the SBR is preferably 15° C. or lower, more preferably 0° C. or lower from the viewpoint of initial grip performance. It is noted that the Tg of the SBR as used herein is in conformity with JIS K 6229, and is a value obtained by removing an extended oil using acetone and measuring a pure SBR content by differential scanning calorimetry measurement (DSC) in accordance with JIS K 7121.

The SBR is not particularly limited. Examples of the SBR include a solution-polymerized SBR (S-SBR), an emulsion-polymerized SBR (E-SBR), modified SBRs thereof (modified S-SBR, modified E-SBR) and the like. Examples of the modified SBRs include end-modified and/or main-chain-modified SBRs, modified SBRs coupled with a tin or silicon compound or the like (such as a condensate, one having a branch structure, etc.), hydrogenated SBRs (hydrogenated S-SBR, hydrogenated E-SBR) and the like. Among these, S—SBR is preferable.

The content of SBR is preferably 80% by mass or more, more preferably 90% by mass or more, further preferably 100% by mass in the rubber component from the viewpoint of grip performance during running and abrasion resistance.

### <Styrene-Butadiene Polymer>

The styrene-butadiene polymer has a weight-average molecular weight of 30,000 or less. The weight-average molecular weight of the styrene-butadiene polymer is preferably 15,000 or less. When the weight-average molecular weight of the styrene-butadiene polymer exceeds 30,000, grip performance during running tends to be deteriorated. The lower limit of the weight-average molecular weight is not limited particularly, but is preferably 4,500 or more from the view point of abrasion resistance. It is noted that the weight-average molecular weight of the styrene-butadiene polymer is measured in the same manner as in the SBR.

It is considered that by combination use of the styrene-butadiene polymer with the SBR, these are mixed sufficiently, thereby enabling E*₇₀ to be decreased and temperature dependency to be reduced.

It is preferable from the viewpoint of abrasion resistance that the styrene-butadiene polymer is a hydrogenated styrene-butadiene polymer. The hydrogenation rate of the styrene-butadiene polymer is preferably 40% or more, more preferably 50% or more, more preferably 60% or more, further preferably 70% or more.

The styrene content of the styrene-butadiene polymer is preferably 30% by mass or more, more preferably 40% by mass or more from the viewpoint of grip performance during running. Further, the styrene content is preferably 60% by mass or less, more preferably 50% by mass or less from the viewpoint of initial grip performance. It is noted that herein, the styrene content of the SBR indicates a content of styrene portions in the styrene-butadiene polymer, and is calculated by H¹-NMR measurement.

The vinyl content of the styrene-butadiene polymer is preferably 30% or more, more preferably 40% or more from the viewpoint of grip performance during running. Further, the vinyl content is preferably 60% or less, more preferably 50% or less from the viewpoint of initial grip performance. It is noted that herein, the vinyl content of the styrene-butadiene polymer indicates a unit quantity of 1,2-bond in a butadiene portion of the styrene-butadiene polymer, and is measured by an infrared absorption spectrum analysis method.

The styrene-butadiene polymer is not limited particularly, and low molecular weight styrene-butadiene polymers which have been used as a softening agent for a rubber composition for a tire can be used. Examples of the styrene-butadiene polymer include a solution-polymerized styrene-butadiene polymer, an emulsion-polymerized styrene-butadiene polymer, modified styrene-butadiene polymers thereof and the like. Among these, a solution-polymerized styrene-butadiene polymer is preferable.

A content of the styrene-butadiene polymer is preferably 20 parts by mass or more, more preferably 25 parts by mass or more, further preferably 35 parts by mass or more based on 100 parts by mass of the rubber component from the viewpoint of grip performance during running. Further, the content of the styrene-butadiene polymer is preferably 100 parts by mass or less, more preferably 70 parts by mass or less, further preferably 50 parts by mass or less based on 100 parts by mass of the rubber component from the viewpoint of grip performance during running.

### <Carbon Black>

The rubber composition for a tread comprises carbon black from the viewpoint of a reinforcing property, resistance to deterioration by ultraviolet light and abrasion resistance. Examples of the carbon black include SAF, ISAF, HAF, FF, FEF, GPF and the like which are usually used in manufacturing of a tire. These carbon black can be used alone or can be used in combination of two or more thereof.

The nitrogen adsorption specific surface area (N₂SA) of carbon black is preferably 100 m²/g or more, more preferably 105 m²/g or more, further preferably 110 m²/g or more from the viewpoint of good grip performance. Further, the N₂SA of carbon black is preferably 600 m²/g or less, more preferably 300 m²/g or less, further preferably 250 m²/g or less from a point that dispersibility in the rubber composition is good and favorable abrasion resistance can be obtained. It is noted that herein, the N₂SA of carbon black is a value measured according to JIS K 6217-2: 2001.

An oil absorption (OAN) of the carbon black is preferably 50 mL/100 g or more, more preferably 100 mL/100 g or more from a point that sufficient abrasion resistance can be obtained. On the other hand, the OAN of the carbon black is preferably 250 mL/100 g or less, more preferably 200 mL/100 g or less, further preferably 135 mL/100 g or less from a point that sufficient grip performance can be obtained. It is noted that the OAN of the carbon black is a value measured in accordance with JIS K6217-4: 2008.

The content of carbon black is preferably 50 parts by mass or more, more preferably 60 parts by mass or more, more preferably 80 parts by mass or more, further preferably 90 parts by mass or more based on 100 parts by mass of the rubber component from a point that sufficient abrasion resistance and grip performance can be obtained. Further, the content of carbon black is preferably 200 parts by mass or less, more preferably 180 parts by mass or less, more preferably 130 parts by mass or less, further preferably 100 parts by mass or less based on 100 parts by mass of the rubber component from a point that grip performance is good.

### <Sulfur>

The rubber composition for a tread comprises sulfur as a vulcanizing agent. Sulfur is not limited particularly, and can be optionally selected from those which have been usually used in the rubber industry. Examples of sulfur include powder sulfur, precipitated sulfur, insoluble sulfur and the like.

The content of sulfur is preferably 0.5 part by mass or more, more preferably 0.6 part by mass or more based on 100 parts by mass of the rubber component from the viewpoint of satisfactory vulcanization reaction. On the other hand, the content of sulfur is preferably 3 parts by mass or less, more preferably 2 parts by mass or less from the viewpoint of grip performance and abrasion resistance.

### <Other Compounding Agents>

In addition to the above-mentioned components, to the rubber composition of the present disclosure can be properly added other compounding agents generally used in the production of a rubber composition, for example, rubber components other than the SBR, a reinforcing filler other than the carbon black, a silane coupling agent, a softening agent other than the styrene-butadiene polymer, stearic acid, zinc oxide, various antioxidants, a wax, a vulcanization accelerator and the like.

(Rubber Components Other than SBR)

Examples of rubber components other than the SBR include diene rubbers other than the SBR such as isoprene rubber including natural rubber (NR) and polyisoprene rubber (IR), butadiene rubber (BR), styrene-isoprene-butadiene rubber (SIBR), chloroprene rubber (CR) and acrylonitrile-butadiene rubber (NBR), and butyl rubbers. These rubber components may be used alone or may be used in combination of two or more thereof. It is preferable that the rubber component comprises NR and BR from the viewpoint of a balance of fuel efficiency, abrasion resistance, durability and wet grip performance. Meanwhile, the rubber component is preferably composed of only SBR because of its good dry grip performance, when used in race tires, especially, race tires for dry road surfaces.

(Reinforcing Filler Other than Carbon Black)

Examples of the reinforcing fillers other than carbon black include silica, calcium carbonate, alumina, clay, talc and the like. From the viewpoint of wet grip performance, it is preferable that the rubber composition comprises silica. From a point of maintaining reinforceability by compounding carbon black, it is preferable that the rubber composition does not comprise reinforcing fillers other than carbon black.

### (Silica)

Silica is not limited particularly, and examples thereof include silica prepared by a dry method (anhydrous silica), silica prepared by a wet method (hydrous silica) and the like. In particular, hydrous silica prepared by a wet method is preferred for the reason that many silanol groups are contained.

A nitrogen adsorption specific surface area (N₂SA) of silica is preferably 80 m²/g or more, more preferably 100 m²/g or more, further preferably 110 m²/g or more from the viewpoint of elongation at break and durability. The N₂SA of silica is preferably 250 m²/g or less, more preferably 235 m²/g or less, further preferably 220 m²/g or less from the viewpoint of fuel efficiency and processability (sheet rollability). The nitrogen adsorption specific surface area of silica is a value measured by the BET method in accordance with ASTM D3037-81.

When the rubber composition comprises silica, for the reason that a sufficient effect of grip performance is obtained, a total amount of silica and carbon black is preferably 50 parts by mass or more, more preferably 60 parts by mass or more, further preferably 80 parts by mass or more, particularly preferably 90 parts by mass or more based on 100 parts by mass of the rubber component. Further, from the viewpoint of processability, the total amount of silica and carbon black is preferably 200 parts by mass or less, more preferably 180 parts by mass or less, further preferably 130 parts by mass or less. A ratio of silica to the total amount of silica and carbon black is preferably 1 part by mass or more and 99 parts by mass or less.

### (Silane Coupling Agent)

Silica is preferably used in combination with a silane coupling agent. The silane coupling agent may be any silane coupling agents conventionally used in conjunction with silica in the rubber industry. Examples of the silane coupling agent include sulfide-based silane coupling agents such as bis(3-triethoxysilylpropyl) disulfide and bis(3-triethoxysilylpropyl) tetrasulfide; mercapto-based silane coupling agents such as 3-mercaptopropyltrimethoxysilane and NXT-Z100, NXT-Z45, NXT and the like manufactured and sold by Momentive Performance Materials (silane coupling agents having a mercapto group); vinyl-based silane coupling agents such as vinyltriethoxysilane; amino-based silane coupling agents such as 3-aminopropyltriethoxysilane; glycidoxy-based silane coupling agents such as γ-glycidoxypropyltriethoxysilane; nitro-based silane coupling agents such as 3-nitropropyltrimethoxysilane; and chloro-based silane coupling agents such as 3-chloropropyltrimethoxysilane. These silane coupling agents may be used alone or may be used in combination of two or more thereof.

When the silane coupling agent is contained, the content thereof is preferably 4.0 parts by mass or more, more preferably 6.0 parts by mass or more based on 100 parts by mass of silica for the reason that sufficient effects of improving dispersibility of fillers and decreasing a viscosity can be obtained. The content of the silane coupling agent is preferably 12 parts by mass or less, more preferably 10 parts by mass or less based on 100 parts by mass of silica. When the content of the silane coupling agent exceeds 12 parts by mass, sufficient coupling effect and filler dispersing effect cannot be obtained and the reinforcing property deteriorates.

(Softening Agent Other than Styrene-Butadiene Polymer)

The softening agent other than the styrene-butadiene polymer is not particularly limited as far as it is one conventionally used in rubber compositions for tires. Examples thereof include an oil, an adhesive resin and a liquid polymer other than the styrene-butadiene polymer.

### <<Oil>>

Examples of the oil include mineral oil such as naphthenic oil, aromatic oil, process oil and paraffinic oil.

When oil is contained, the content thereof is preferably 5 parts by mass or more, more preferably 15 parts by mass or more based on 100 parts by mass of the rubber component for the reason that an effect obtained by compounding the oil is sufficient. Further, the content of the oil is preferably 50 parts by mass or less, more preferably 45 parts by mass or less based on 100 parts by mass of the rubber component from the viewpoint of abrasion resistance.

### <<Adhesive Resin>>

Examples of the adhesive resin include resins such as aromatic petroleum resins which have been commonly used for rubber compositions for tires. Examples of the aromatic petroleum resins include a phenolic resin, a coumarone-indene resin, a terpene resin, a styrene resin, an acrylic resin, a rosin resin, a dicyclopentadiene resin (DCPD resin) and the like. Examples of the phenolic resin include Koreshin (available from BASF Japan), TACKIROL (available from Taoka Chemical Co., Ltd.) and the like. Examples of the coumarone-indene resin include ESCRONE (available from Nippon Steel & Sumikin Chemical Co., Ltd.), Neo Polymer (available from JXTG Nippon Oil & Energy Corporation) and the like. Examples of the styrene resin include SYLVATRAXX 4401 (available from Arizona Chemical Company) and the like. Examples of the terpene resin include TR7125 (available from Arizona Chemical Company), TO125 (available from Yasuhara Chemical Co., Ltd.) and the like. These adhesive resins may be used alone or may be used in combination of two or more thereof. Among these, it is preferable to use a phenolic resin, a coumarone-indene resin, a terpene resin and an acrylic resin from the viewpoint of good grip performance during running.

When the adhesive resin is contained, the content thereof is preferably 35 parts by mass or more, more preferably 45 parts by mass or more, further preferably 50 parts by mass or more based on 100 parts by mass of the rubber component from the viewpoint of grip performance during running. Further, from the viewpoint of processability, the content of the adhesive resin is preferably 120 parts by mass or less, more preferably 105 parts by mass or less, further preferably 95 parts by mass or less based on 100 parts by mass of the rubber component.

<<Liquid Polymer Other than Styrene-Butadiene Polymer>>

Examples of the liquid polymer other than the styrene-butadiene polymer include a liquid butadiene polymer, a liquid isoprene polymer, a liquid styrene isoprene polymer and the like. In particular, it is preferable not to contain a liquid polymer other than a styrene butadiene polymer because durability and grip performance can be improved in good balance.

### (Antioxidant)

The antioxidant is not particularly limited, and any antioxidants conventionally used in a field of rubbers can be used. Examples of the antioxidant include quinoline-based antioxidants, quinone-based antioxidants, phenol-based antioxidants, phenylenediamine-based antioxidants and the like.

When the antioxidant is contained, the content thereof is preferably 0.5 part by mass or more, more preferably 0.8 part by mass or more based on 100 parts by mass of the rubber component. Further, the content of the antioxidant is preferably 3.0 parts by mass or less, more preferably 2.7 parts by mass or less, further preferably 2.5 parts by mass or less based on 100 parts by mass of the rubber component from the viewpoint of dispersibility of the filler and the like, elongation at break and kneading efficiency.

### (Vulcanization Accelerator)

Examples of the vulcanization accelerator include guanidine-based vulcanization accelerators, aldehyde-amine-based vulcanization accelerators, aldehyde-ammonia-based vulcanization accelerators, thiazole-based vulcanization accelerators, sulfenamide-based vulcanization accelerators, thiourea-based vulcanization accelerators, thiuram-based vulcanization accelerators, dithiocarbamate-based vulcanization accelerators, xanthate-based vulcanization accelerators and the like. Among these, the vulcanization accelerator is preferably a vulcanization accelerator having a benzothiazolyl sulfide group for the reason that an effect of the present disclosure can be obtained suitably.

Examples of the vulcanization accelerator having the benzothiazolyl sulfide group include sulfenamide-based vulcanization accelerators such as N-tert-butyl-2-benzothiazolylsulfenamide (TBBS), N-cyclohexyl-2-benzothiazolylsulfenamide (CBS), N,N-dicyclohexyl-2-benzothiazolylsulfenamide (DCBS), N,N-diisopropyl-2-benzothiazolesulfenamide, N,N-di(2-ethylhexyl)-2-benzothiazolylsulfenamide (BEHZ), N,N-di(2-methylhexyl)-2-benzothiazolylsulfenamide (BMHZ) and N-ethyl-N-t-butylbenzothiazole-2-sulfenamide (ETZ); N-tert-butyl-2-benzothiazolylsulfenimide (TBSI); di-2-benzothiazolyl disulfide (DM); and the like.

When the vulcanization accelerator is contained, the content thereof is preferably 0.5 part by mass or more, more preferably 1.0 part by mass or more based on 100 parts by mass of the rubber component from the viewpoint of securing sufficient vulcanization rate. Further, the content of the vulcanization accelerator is preferably 10 parts by mass or less, more preferably 8 parts by mass or less based on 100 parts by mass of the rubber component from the viewpoint of inhibiting blooming.

### <Rubber Composition for Tread>

The rubber composition for a tread of the present embodiment can be prepared by a usual method. For example, the rubber composition can be prepared by a method of kneading each of the above-mentioned components except the vulcanizing agent and the vulcanization accelerator using a well-known kneading apparatus which is generally used in rubber industries such as a Banbury mixer, a kneader or an open roll, and then adding the vulcanizing agent and the vulcanization accelerator, followed by further kneading a mixture and conducting vulcanization, or the like method.

### <Tire>

The tire of the present embodiment can be produced by a usual method using the above-mentioned rubber composition for a tread. Namely the rubber composition prepared by compounding the above-mentioned compounding agents with the rubber component as required is extrusion-processed into a shape of a tread, and further, the obtained extruded product is laminated with other tire parts to form an unvulcanized tire on a tire molding machine by a usual forming method. The tire can be produced by heating and pressurizing this unvulcanized tire in a vulcanizer.

### Preferred Embodiment

Preferred embodiments of the present disclosure are as follows.

[1] A tire comprising a tread composed of a rubber composition for the tread, the rubber composition comprising a styrene-butadiene rubber having a weight-average molecular weight of 700,000 or more, preferably 900,000 or more, more preferably 1,100,000 or more, a high content of styrene monomer and a vinyl content of 30 to 55%, preferably 35 to 50%, more preferably 40 to 45%, a styrene-butadiene polymer having a weight-average molecular weight of 30,000 or less, preferably 15,000 or less, carbon black and sulfur.
[2] The tire of above [1], wherein in the styrene-butadiene rubber, a content of dimers and trimers of styrene is 5 to 20%, preferably 10 to 20%, more preferably 13 to 17%, and a content of tetramers and higher multimers of styrene is 10% or less, preferably 7% or less.
[3] The tire of above [1] or [2], wherein a styrene content of the styrene-butadiene rubber is 30 to 55% by mass, preferably 35 to 50% by mass, more preferably 40 to 45% by mass.
[4] A rubber composition for a tread having a complex elastic modulus E*₇₀ at 70° C. of 30 to 110 MPa, preferably 40 to 100 MPa, more preferably 50 to 90 MPa which satisfies the following equation (1):

1≤(E*₅₀+E*₁₀₀)/(2×E*₇₀)≤100 (1)

wherein E*n is a complex elastic modulus at n° C.

### Examples

The present disclosure is described in detail based on Examples. The present disclosure is not limited to these Examples.

Various chemicals used in Examples and Comparative Examples are shown below.

SBR 1 to SBR 8: prepared by manufacturing methods for SBR 1 to SBR 8 described below, and physical properties thereof are shown in Table 1.
Carbon Black: Carbon Black (N₂SA: 230 m²/g)
Polymer 1: Liquid SBR (styrene content: 50% by mass, weight-average molecular weight: 6,000, hydrogenation rate: 70%)
Polymer 2: Liquid SBR (styrene content: 50% by mass, weight-average molecular weight: 20,000, hydrogenation rate: 70%)
Polymer 3: Liquid SBR (styrene content: 50% by mass, weight-average molecular weight: 50,000, hydrogenation rate: 70%)
Naphthenic oil: available from JXTG Nippon Oil & Energy Corporation
Resin 1: Koreshin (phenolic resin) available from BASF Japan
Resin 2: Nisseki Neo Polymer available from JXTG Nippon Oil & Energy Corporation (coumarone-indene resin)
Antioxidant 1: Nocrac 6C manufactured by Ouchi Shinko Chemical Industrial Co., Ltd. (N-(1,3-dimethylbutyl)-N′-phenyl-p-phenylenediamine)
Antioxidant 2: Nocrac RD manufactured by Ouchi Shinko Chemical Industrial Co., Ltd. (poly(2,2,4-trimethyl-1,2-dihydroquinone)
Stearic acid: Bead stearic acid “TSUBAKI” manufactured by NOF Corporation
Zinc oxide: Fine particle zinc oxide (average primary particle size: 100 nm)
Sulfur: HK-200-5 available from Hosoi Chemical Industry Co., Ltd. (powdered sulfur containing 1.5% oil)
Vulcanization accelerator 1: NOCCELER DM manufactured by Ouchi Shinko Chemical Industrial Co., Ltd. (di-2-benzothiazolyl disulfide)
Vulcanization accelerator 2: NOCCELER TOT-N manufactured by Ouchi Shinko Chemical Industrial Co., Ltd. (tetrakis(2-ethylhexyl)thiuram disulfide)

Various chemicals used in the manufacturing methods for SBR 1 to SBR 8 are as follows.

Cyclohexane: manufactured by Kanto Chemical Co., Inc.
1.6M n-butyllithium hexane solution: manufactured by Kanto Chemical Co., Inc.
Isopropanol: manufactured by Kanto Chemical Co., Inc.
Styrene: manufactured by Kanto Chemical Co., Inc.
Butadiene: 1,3-butadiene manufactured by Takachiho Chemical Industrial Co., Ltd.
Tetramethylethylenediamine (TMEDA): N, N, N′, N′-tetramethylethylenediamine, manufactured by Kanto Chemical Co., Inc.

### Manufacturing Method of SBR 1

A 3 L pressure-resistant stainless-steel vessel, fully nitrogen-purged, was charged with TMEDA (20 mmol) and n-butyllithium/hexane solution (in which the content of n-butyllithium was 0.083 mmol). Subsequently, a hexane solution (1,000 g) of butadiene (60 g) and styrene (40 g) was gradually added dropwise in such a manner that a temperature difference at the time of the addition is 20° C. or less. After completion of a polymerization reaction for three hours at 50° C., 1,500 mL of 1M isopropanol/hexane solution was added dropwise to the resulting mixture to terminate the reaction. Thereafter, the polymerization solution was evaporated for 24 hours at room temperature and further dried for 24 hours at 80° C. under reduced pressure, thereby producing an SBR 1.

### Manufacturing Method of SBR 2

SBR 2 was obtained by the same method as in the Production Method of SBR 1 using the same materials and apparatus as in the Production Method of SBR 1 except that the reaction conditions were changed.

### Manufacturing Method of SBR 3

A 3 L pressure-resistant stainless-steel vessel, fully nitrogen-purged, was charged with 1,000 g of hexane, 60 g of butadiene, 40 g of styrene and 20 mmol of TMEDA. Subsequently, a small amount of n-butyllithium/hexane solution was put into the polymerization vessel as a scavenger for previously neutralizing impurities that would affect deactivation of a polymerization initiator. Further, an n-butyllithium/hexane solution (in which the content of n-butyllithium was 0.083 mmol) was added thereto, followed by polymerization reaction for three hours at 50° C. Then, 1,500 mL of 1M isopropanol/hexane solution was added dropwise to the mixture to terminate the reaction. Thereafter, the polymerization solution was evaporated for 24 hours at room temperature and further dried for 24 hours at 80° C. under reduced pressure, thereby producing an SBR 3.

### Manufacturing Method of SBR 4

SBR 4 was obtained by the same method as in the Production Method of SBR 3 using the same materials and apparatus as in the Production Method of SBR 3 except that the adding amount of n-butyllithium/hexane solution and the reaction conditions were changed.

### Manufacturing Method of SBR 5

SBR 5 was obtained by the same method as in the Production Methods of SBR 3 and 4 using the same materials and apparatus as in the Production Method of SBR 3 except that the adding amount of n-butyllithium/hexane solution and the reaction conditions were changed.

### Manufacturing Method of SBR 6

SBR 6 was obtained by the same methods as in the Production Methods of SBR 3 to SBR 5 using the same materials and apparatus as in the Production Method of SBR 3 except that the reaction conditions were changed.

### Manufacturing Method of SBR 7

SBR 7 was obtained by the same methods as in the Production Methods of SBR 3 to SBR 6 using the same materials and apparatus as in the Production Method of SBR 3 except that the reaction conditions were changed.

### Manufacturing Method of SBR 8

SBR 8 was obtained by the same method as in the Production Methods of SBR 1 and 2 using the same materials and apparatus as in the Production Method of SBR 1 except that the adding amount of styrene and the reaction conditions were changed.

Styrene contents, vinyl contents, glass transition points (Tg), weight average molecular weights (Mw), contents of styrene dimers and trimers and contents of tetramers and higher multimers of styrene of the obtained SBR 1 to SBR 8 are shown in Table 1.

TABLE 1

| | SBR | | | | | | | |
|---|---|---|---|---|---|---|---|---|
| | 1 | 2 | 3 | 4 | 5 | 6 | 7 | 8 |
| Styrene content | 40 | 40 | 40 | 40 | 40 | 40 | 40 | 30 |
| (% by mass) | | | | | | | | |
| Vinyl content (%) | 40 | 40 | 35 | 40 | 28 | 25 | 25 | 60 |
| Tg (° C.) | −10 | −10 | −12 | −10 | −18 | −20 | −20 | −10 |
| Mw | 1200000 | 1200000 | 1200000 | 500000 | 1000000 | 1000000 | 1000000 | 1200000 |
| Content of styrene | 15 | 5 | 20 | 5 | 25 | 10 | 15 | 15 |
| dimers and trimers (%) | | | | | | | | |
| Content of tetramers | 5 | 10 | 20 | 20 | 15 | 15 | 15 | 5 |
| and higher multimers | | | | | | | | |
| of styrene (%) | | | | | | | | |

### Examples and Comparative Examples

According to the compounding formulations shown in Tables 2 and 3, all chemicals, other than sulfur and a vulcanization accelerator, were kneaded using a 1.7 L sealed Banbury mixer for five minutes up to a discharge temperature of 170° C. to obtain a kneaded product. Then, the obtained kneaded product was kneaded again (remilled) at a discharge temperature of 150° C. for four minutes by the Banbury mixer. Then, sulfur and a vulcanization accelerator were added to the obtained kneaded product, and kneaded for 4 minutes up to 105° C. using a biaxial open roll to obtain an unvulcanized rubber composition. The obtained unvulcanized rubber composition was subjected to press-vulcanization at 170° C. for 12 minutes to obtain a test rubber composition.

Further, the obtained unvulcanized rubber composition was extruded and molded into the shape of a tire tread by an extruder equipped with a base having a predetermined shape, and then laminated with other tire members to form an unvulcanized tire, which was then press-vulcanized at 170° C. for 12 minutes to manufacture a test tire (size: 195/65R15).

The obtained test rubber compositions and test tires were subjected to the following evaluation. The results are shown in Tables 2 and 3.

<Tensile Stress at 300% Elongation (M300)>

No. 1 dumbbell type test piece was produced using each of the test rubber compositions according to JIS K 6251: 2010, and a tensile stress M300 (MPa) at 300% elongation was measured using the test piece according to the method described in JIS K 6251: 2010. The results of the measurement are represented by indices, assuming that the index of M300 of Comparative Example 2 was 100. The larger the index is, the better the abrasion resistance is.

<Viscoelasticity Test>

A complex elastic modulus E*so under the conditions of 50° C., an initial strain of 10%, a dynamic strain of 2% and a frequency of 10 Hz; a complex elastic modulus E*₇₀ under the conditions of 70° C., an initial strain of 10%, a dynamic strain of 2%/0 and a frequency of 10 Hz; a complex elastic modulus E*₁₀₀ under the conditions of 100° C., an initial strain of 10%, a dynamic strain of 2% and a frequency of 10 Hz; and tan δ (100° C. tan δ) were measured for each of the test rubber compositions using a viscoelasticity spectrometer manufactured by IWAMOTO Quartz GlassLabo Co., Ltd. The values of the following formula (1) were calculated from the obtained complex elastic modulus. The value of the formula (1) being closer to 1 represents less temperature dependency. Further, the 100° C. tan δ represents an index assuming that the index of Comparative Example 2 was 100. The larger the index is, the better the grip performance during running is. The target value of the 100° C. tan δ is 90 or more.

(E*₅₀+E*₁₀₀)/(2×E*₇₀) (1)

<Initial Grip Performance>

The respective test tires were mounted on all wheels of a domestic FR vehicle with a displacement of 2,000 cc, and the vehicle was actually run 10 times on a dry asphalt road surface of a test course. The steering stability of control on the dry asphalt road surface during the second lap was evaluated by a test driver. The result of each of the test tires is indicated by an index, assuming that the stability of Comparative Example 2 is 100. It shows that the larger the index is, the higher the initial grip performance is.

<Abrasion Resistance>

The respective test tires were mounted on all wheels of a domestic FR vehicle with a displacement of 2,000 cc, and after running a distance of 8,000 kin, a groove depth of a tire tread portion was measured. Then, a running distance when the tire groove depth was reduced by 1 mm was measured. The result of each of the test tires is indicated by an index, assuming that a running distance when a tire groove of Comparative Example 2 was reduced by 1 mm is 100. It shows that the larger the index is, the better the abrasion resistance is.

TABLE 2

| | Example | | Comparative Examples | | | | | |
|---|---|---|---|---|---|---|---|---|
| | 1 | 2 | 1 | 2 | 3 | 4 | 5 | 6 |
| Compounding | | | | | | | | |
| amount | | | | | | | | |
| (part by mass) | | | | | | | | |
| SBR1 | 100 | — | — | — | — | — | — | — |
| SBR2 | — | 100 | — | — | — | — | — | — |
| SBR3 | — | — | 100 | — | — | — | — | — |
| SBR4 | — | — | — | 100 | — | — | — | — |
| SBR5 | — | — | — | — | 100 | — | — | — |
| SBR6 | — | — | — | — | — | 100 | — | — |
| SBR7 | — | — | — | — | — | — | 100 | — |
| SBR8 | — | — | — | — | — | — | — | 100 |
| Carbon black | 95 | 95 | 95 | 95 | 95 | 95 | 95 | 95 |
| Polymer 1 | 35 | 35 | 35 | 35 | 35 | 35 | 35 | 35 |
| Polymer 2 | — | — | — | — | — | — | — | — |
| Polymer 3 | — | — | — | — | — | — | — | — |
| Naphthenic oil | 40 | 40 | 40 | 40 | 40 | 40 | 40 | 40 |
| Resin 1 | 65 | 65 | 65 | 65 | 65 | 65 | 65 | 65 |
| Resin 2 | 30 | 30 | 30 | 30 | 30 | 30 | 30 | 30 |
| Antioxidant 1 | 1.5 | 1.5 | 1.5 | 1.5 | 1.5 | 1.5 | 1.5 | 1.5 |
| Antioxidant 2 | 1 | 1 | 1 | 1 | 1 | 1 | 1 | 1 |
| Stearic acid | 1 | 1 | 1 | 1 | 1 | 1 | 1 | 1 |
| Zinc oxide | 2 | 2 | 2 | 2 | 2 | 2 | 2 | 2 |
| Sulfur | 1 | 1 | 1 | 1 | 1 | 1 | 1 | 1 |
| Vulcanization | 3 | 3 | 3 | 3 | 3 | 3 | 3 | 3 |
| accelerator 1 | | | | | | | | |
| Vulcanization | 5 | 5 | 5 | 5 | 5 | 5 | 5 | 5 |
| accelerator 2 | | | | | | | | |
| Evaluation | | | | | | | | |
| M300 (MPa) | 150 | 150 | 150 | 100 | 130 | 130 | 130 | 130 |
| E*₇₀ | 60 | 65 | 120 | 100 | 125 | 110 | 115 | 105 |
| Value of | 6.5 | 7.0 | 12 | 10 | 18 | 13 | 15 | 11 |
| equation (1) | | | | | | | | |
| 100° C. tanδ | 130 | 100 | 100 | 100 | 100 | 100 | 80 | 80 |
| Initial grip | 125 | 120 | 80 | 100 | 75 | 90 | 85 | 95 |
| performance | | | | | | | | |
| Abrasion | 150 | 150 | 150 | 100 | 103 | 130 | 130 | 120 |
| resistance | | | | | | | | |

TABLE 3

| | Examples | | | | Com. Ex. | |
|---|---|---|---|---|---|---|
| | 3 | 4 | 5 | 6 | 7 | 8 |
| Compounding amount | | | | | | |
| (part by mass) | | | | | | |
| SBR1 | 100 | — | 100 | — | 100 | — |
| SBR2 | — | 100 | — | 100 | — | 100 |
| SBR3 | — | — | — | — | — | — |
| SBR4 | — | — | — | — | — | — |
| SBR5 | — | — | — | — | — | — |
| SBR6 | — | — | — | — | — | — |
| SBR7 | — | — | — | — | — | — |
| SBR8 | — | — | — | — | — | — |
| Carbon black | 95 | 95 | 60 | 60 | 95 | 95 |
| Polymer 1 | — | — | 35 | 35 | — | — |
| Polymer 2 | 35 | 35 | — | — | — | — |
| Polymer 3 | — | — | — | — | 35 | 35 |
| Naphthenic oil | 40 | 40 | 40 | 40 | 40 | 40 |
| Resin 1 | 65 | 65 | 65 | 65 | 65 | 65 |
| Resin 2 | 30 | 30 | 30 | 30 | 30 | 30 |
| Antioxidant 1 | 1.5 | 1.5 | 1.5 | 1.5 | 1.5 | 1.5 |
| Antioxidant 2 | 1 | 1 | 1 | 1 | 1 | 1 |
| Ste aric acid | 1 | 1 | 1 | 1 | 1 | 1 |
| Zinc oxide | 2 | 2 | 2 | 2 | 9 | 2 |
| Sulfur | 1 | 1 | 1 | 1 | 1 | 1 |
| Vulcanization | 1 | 3 | 3 | 3 | 3 | 3 |
| accelerator 1 | | | | | | |
| Vulcanization | 5 | 5 | 5 | 5 | 5 | 5 |
| accelerator 2 | | | | | | |
| Evaluation | | | | | | |
| M300 (MPa) | 180 | 180 | 130 | 130 | 200 | 200 |
| E*₇₀ | 60 | 65 | 90 | 95 | 85 | 90 |
| Value of equation (1) | 6.5 | 7.0 | 5.0 | 5.5 | 6.5 | 7.0 |
| 100° C. tanδ | 120 | 95 | 110 | 90 | 85 | 80 |
| Initial grip performance | 125 | 120 | 120 | 110 | 125 | 120 |
| abrasion resistance | 180 | 150 | 130 | 130 | 200 | 200 |

It is seen from the results shown in Tables 2 and 3 that the tires of the present disclosure having a tread composed of the specific rubber composition are good in initial grip performance. The reason for that is considered to be such that since a styrene content of the SBR is as high as 35% or more, temperature dependency of the E* at around 70° C. can be inhibited to be as low as possible and tan δ at 100° C. can be kept high, thereby enabling peak grip performance to be improved. Further, it is seen from the results shown in Tables 2 and 3 that abrasion resistance of the tread of the tire of the present disclosure is maintained. The reason for that is considered to be such that since a weight-average molecular weight of the SBR having a high content of styrene monomer is as high as 700,000 or more, temperature dependency of the E*at around 70° C. can be inhibited to be as low as possible and the M300 can be kept high, thereby enabling generation of abrasion to be inhibited.

What is claimed is:

1. A tire comprising a tread composed of a rubber composition for the tread, the rubber composition comprising a styrene-butadiene rubber having a weight-average molecular weight of 700,000 or more, a high content of styrene monomer and a vinyl content of 30 to 55%, a styrene-butadiene polymer having a weight-average molecular weight of 30,000 or less, carbon black and sulfur.

2. The tire of claim 1, wherein in the styrene-butadiene rubber, a content of dimers and trimers of styrene is 5 to 20% and a content of tetramers and higher multimers of styrene is 10% or less.

3. The tire of claim 1, wherein a styrene content of the styrene-butadiene rubber is 30 to 55% by mass.

4. A rubber composition for a tread having a complex elastic modulus E*₇₀ at 70° C. of 30 to 110 MPa which satisfies the following equation (1):
1≤(E*₅₀+E*₁₀₀)/(2×E*₇₀)≤100 (1)
wherein E*n is a complex elastic modulus at n° C.
